(19) United States
(12) Patent Application Publication
(10) Pub. No.: US 2005/0112443 A1
(43) Pub. Date: May 26, 2005

(54) Coated aluminum separator plates for fuel cells

(76) Inventors: Jane Allin, Kingston (CA); Gregory J. Courval, Napanee (CA)

Correspondence Address: Christopher C. Dunham;c/o Cooper & Dunham LLP, 1185 Ave. of the Americas, New York, NY, 10036, US

(21) Appl. No.: 10/973,602

(22) Filed: Oct. 26, 2004

Related U.S. Application Data
(60) Provisional application No. 60/514,995, filed on Oct. 27, 2003.

(51) Int. Cl. H01M 4/86; B05D 5/12

(52) U.S. Cl. 429/34; 427/115; 429/44; 429/42

(57) ABSTRACT

A method of producing a separator plate for a low temperature fuel cell. In the method, a sheet article made of aluminum or aluminum alloy is coated with a layer of an electrically-conductive heat-activated polymerizable material, preferably dissolved or suspended in a volatile liquid. The article is preferably heated to a temperature below the full-cure temperature to drive off the volatile liquid to create a dried layer of polymerizable material. The surface is then coated with a catalyst to produce a catalyst-coated layer of polymerizable material. The article is then heated to the full-cure temperature to fully polymerize the polymerizable material and to attach the catalyst. The invention also relate to a separator plate having a structure indicated above.

### CROSS-REFERENCE TO RELATED APPLICATION

This invention claims the priority right of our prior corresponding Provisional Patent Application Ser. No. 60/514,995 filed Oct. 27, 2003.

### FIELD OF THE INVENTION

This invention relates to separator plates used for fuel cell applications. More particularly, the invention relates to plates of this kind made of aluminum or aluminum alloys and to the coating of such plates to provide chemical resistance and catalytic activity.

### BACKGROUND ART

Fuel cells are becoming increasingly important as sources of alternative energy. In general, there are two types of fuel cells, i.e. high temperature cells that use solid oxide catalysts and typically operate at temperatures in the range of 700 to 1,000° C., and low temperature cells, e.g. cells that employ proton exchange membranes (PEMs) and operate at temperatures usually in the range of 60 to 160° C. (preferably 80-120° C.). The present invention relates to cells of the latter type, i.e. low temperature cells that operate at temperatures less than about 200° C. Such cells make use of internal separator plates, particularly bipolar separators, which have two main functions. Firstly, they must provide electrical contact between the anodes and cathodes of neighbouring cells and, secondly, they must provide a structured surface to guide reaction gases into the cells and reaction products out. The separators may be provided with catalysts for facilitating the energy-generating reactions. Furthermore, as the reactions occur at temperatures within the stated range and at low pH, the plates must have good chemical resistance.

As a material for forming such separator plates, aluminum certainly fulfils the main requirements in terms of electrical conductivity and ability to be roll-formed or stamped (thus facilitating their fabrication). However, the elevated operating temperatures and acidic medium are very corrosive to aluminum. This has led a great deal of research into the use of conductive plastics for separator plates in place of aluminum and other metals. Nevertheless, suitable plastics can be very much more expensive than aluminum and their inherent conductivity is less than desirable.

Attempts have been made to provide aluminum plates with protective, yet electrically-conductive, coatings or layers to improve their effectiveness in fuel cells.

For example, U.S. Pat. No. 5,624,769, which issued on Apr. 29, 1997 to Yang Li, et al., discloses a core made of a light-weight metal (e.g. Al or Ti) having a coating of titanium nitride and an intermediate layer between the metal core and the titanium nitride. The intermediate layer comprises a passivating, protective metal, e.g. stainless steel rich in chromium, nickel and molybdenum. The titanium nitride is said to provide corrosion protection and the intermediate layer forms a layer of oxide that acts as a barrier to further corrosion at sites where the layer is exposed to the corrosive environment.

U.S. patent application Ser. No. 09/778,002, which was published on Jan. 3, 2002 under publication No. 2002/0001743 in the name of John Herbert Davis, discloses a separator plate having a core made of metal (e.g. aluminum) and cladding layers of electrically-conductive material mechanically bonded to opposing faces of the core.

PCT patent WO 03/009408, which published on Jan. 30, 2003 in the name of John Herbert Davis (assigned to Avantcell of Quebec, Canada), discloses a method of treating a surface of an aluminum to provide corrosion resistance in PEM fuel cells. In this publication, a thin layer of a noble metal (e.g. silver) is provided between the aluminum core and a conductive outer layer. The layer of noble metal maintains good electrical contact between the core metal layer and the outer conductive material.

U.S. patent application Ser. No. 09/737,268, which was published on Jun. 13, 2002 under publication No. 2002/0071797 in the name of Daniel G. Loffler, et al., discloses a separator plate provided with a coating containing catalysts used in reforming fuel to hydrogen. The plate may be made of aluminum-containing or aluminum-treated steels and the like, and is coated with a layer of catalyst. The aluminum content, upon oxidation, causes whisker formation at the surface for better bonding of the layer of catalyst. The catalytic coating (typically mixed oxides containing catalytic metals such as Pt and Pd) may be applied as a suspension or sol by spraying, direct coating, dipping, and the like. The coating is then dried and heat-treated in air at temperatures of 700° C. and above.

There is a need for an improved way of producing catalyst-containing layers on aluminum core structures for use in PEM-type fuel cells.

### SUMMARY OF THE INVENTION

An object of the present invention, at least in preferred forms, is to produce a separator plate for a low temperature fuel cell that uses aluminum as the core component, has good chemical resistance and can also provide a suitable surface to which a catalyst can be bonded.

According to one aspect of the invention, there is provided a method of producing a separator plate (preferably a bipolar separator plate) for a low temperature fuel cell. The method comprises providing a sheet article made of aluminum or aluminum alloy; applying a layer of an electrically-conductive polymerizable material to a surface of the sheet article, the polymerizable material requiring an activation procedure to cause the material to polymerize fully; coating the surface of the layer of electrically-conductive polymerizable material with at least one solid particulate catalyst to form a catalyst-coated layer of polymerizable material; and subjecting the catalyst-coated layer of polymerizable material to the activation procedure to fully polymerize the polymerizable material to form a layer of polymerized electrically-conductive polymer adhering to the surface of the sheet article and to the catalyst(s) provided on the surface of the polymerized electrically-conductive polymer layer.

More preferably, the invention provides a method of producing a bipolar separator plate for a low temperature (e.g. PEM-type) fuel cell, which comprises: providing a sheet article made of aluminum or aluminum alloy; applying a layer of an electrically-conductive heat-activated polymerizable material dissolved or suspended in a volatile liquid to a surface of the sheet article, the polymerizable material being a material that must be heated to or beyond an activation temperature to become fully polymerized; heating the sheet article and the applied layer to a temperature below the activation temperature to drive off the volatile liquid to create a semi-dry layer of polymerizable material; coating a surface of the dried layer of polymerizable material with at least one solid particulate catalyst to produce a catalyst-coated layer of polymerizable material; and heating the catalyst-coated layer of polymerizable material to a temperature at or above the activation temperature to fully polymerize the polymerizable material to form a layer of polymerized electrically-conductive polymer and thereby adhering the at least one catalyst at a surface of the polymerized electrically-conductive polymer layer.

Most preferably, the surface of the sheet article is first subjected to a procedure that enhances the adhesion of the layer of polymerized material to the aluminum in the final product. This treatment may be, for example, etching, anodizing, conversion coating or mechanical roughening (e.g. brushing).

According to another aspect of the invention, there is provided a separator plate for a low temperature fuel cell, comprising: a core made of aluminum or an aluminum alloy in the form of a sheet article; a layer of an electrically-conductive polymer on a surface of the core; and particles of a solid catalyst attached to an outer surface of the layer of electrically-conductive polymer.

The polymerizable material may be organic and may be heat-curable or curable at low (e.g. room) temperature (e.g. by exposure to moisture, light, UV radiation, or other form of radiation). Heat-curable organic polymerizable materials are currently preferred. The polymerizable materials may be inherently electrically conductive, but even if not, they may be made suitably conductive by the addition of suitable amounts of conductive particles, e.g. of carbon (such as carbon black or graphite) or corrosion-resistant metals. Such additions should be sufficient to provide the required electrical conductivity without compromising the required chemical resistance of an applied layer when polymerized.

The layer of polymerizable material may be applied to the aluminum sheet article by any suitable means, e.g. spraying, roll-coating, dipping, etc. The thickness and integrity of the applied layer should be sufficient to provide the required resistance to chemical attack for the perceived lifetime of the cell, while allowing for suitable conduction of electricity. As for the sheet article itself, this should be thick enough and of a shape suitable to provide the structural requirements of this part of a fuel cell.

By the term “sheet article” as used herein, we mean to include extrusions of aluminum or aluminum alloy as well as flat plates or sheets that may be of a size to form an individual separator plate or large enough to form a plurality of bipolar separator plates. Moreover, the coating process herein described may be carried out continuously or batch-wise.

The invention, at least in its preferred forms, makes it possible to employ relatively inexpensive materials and an easy method of fabrication while providing a separator plate having good electrical conductivity and durability.

### BRIEF DESCRIPTION OF THE DRAWINGS

FIG. 1 is a schematic drawing illustrating one form of the method of the present invention;

FIG. 2 is a cross-section of a separator plate for a fuel cell according to one preferred embodiment of the invention showing various layers; and

FIGS. 3 and 4 are scanning electron micrograph images of samples described in the Examples below.

### DETAILED DESCRIPTION OF THE INVENTION

The present invention makes it possible to fabricate a bipolar separator plate for a fuel cell using aluminum as the core material to provide good conductivity of electricity and heat while at the same time providing the core metal with good corrosion resistance and preferably surface attachment of a catalyst for the reactions carried out in the cell.

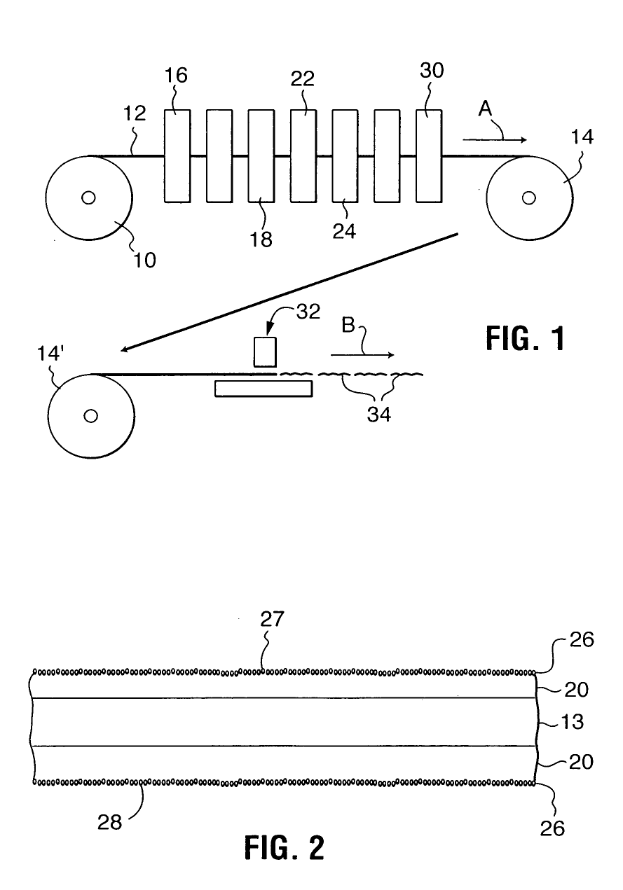

A preferred form of the method of the invention is illustrated in FIG. 1 and an example of a resulting separator plate is shown in FIG. 2. A coil 10 of aluminum alloy sheet (e.g. AA5182 aluminum alloy) is uncoiled to form a sheet article 12 of aluminum sheet material advancing in the direction of arrow A. This sheet article forms the metal core layer 13 of the eventual separator plate. The advancing sheet article is normally re-coiled after coating to form a second coil 14 but, before doing so, the advancing sheet article passes through a number of treatment stations where steps of the method are carried out on a continuous basis, preferably on both sides of the band simultaneously but optionally on one side only. At treatment station 16, the sheet article is given a surface treatment that will enhance the adhesion of the subsequently applied polymer layer. The surface treatment may be of any suitable kind, for example etching, anodizing, conversion coating or mechanical roughening.

At a second treatment station 18, the aluminum sheet article is coated on both sides with a layer 20 of polymerizable material (see FIG. 2) to provide chemical resistance. The polymerizable material may be an organic material (e.g. a curable epoxy resin or polyester). However, it must also be electrically conductive to a suitable degree to allow passage of electrical current. If the polymerizable material itself is not suitably conductive, it can be made so by the addition of conductive particles made, for example, of carbon (carbon black). The polymerizable material itself must be chemically resistant in the environment of the fuel cell and capable of protecting the underlying metal from chemical attack (i.e. it should form a continuous fluid-impenetrable film). The polymerizable material is generally mixed with a volatile solvent (e.g. hydrocarbons, ketones, glycols, esters, or other suitable solvent combinations) so that it can be caused to flow more easily and evenly during the coating process. The material is also heat-curable so that full thermoplastic or thermosetting cross-linking takes place when the material is heated to an elevated activation (full-cure) temperature.

Once the polymerizable material has been applied as a coating 20, the sheet article advances to treatment station 22 where the sheet article and applied coating are heated to a temperature below the activation temperature of the polymerizable material to drive off the volatile solvent and, if desired, to bring about partial (but not full) cross-linking or curing. The intention is to make the surface of the layers 20 dry or semi-dry without causing full cross-linking of the polymerizable material. In the process of this invention, temperatures are most easily measured as peak metal temperatures (highest measured temperature of the metal core layer). In this step, depending on the polymerizable material and volatile solvent employed, the peak metal temperature is generally in the range of 60 to 100° C. and the process often takes a time of about 5 to 20 seconds.

The sheet article is then advanced to treatment station 24 where a layer 26 of catalyst particles 27 is applied to the surfaces of the polymer coatings 20. This can be achieved by any suitable means, e.g. by spraying the particulate solid mixed with a volatile suspension liquid (e.g. methanol) onto the surfaces so that the volatile suspension liquid evaporates to leave a thin layer of solid particles. However, if desired, the catalyst may be applied by passing the coated sheet through a fluidized bed of the catalyst particles or the catalyst may be applied to limited areas of the surface by spraying the solid through a mask or the like. At this stage, the particles are held only loosely to the surfaces of the layers 20, mainly by electrostatic charge or residual slight tackiness of the surfaces. The catalyst may be of any suitable kind, but is preferably very finely divided platinum powder.

The sheet article is then advanced to treatment station 30 where the sheet article is subjected to a final heat treatment at or above the activation temperature to bring about full cross-linking or curing of the polymerizable material. Depending on the materials employed, this step may be carried out at a peak metal temperature in the range of 160 to 260° C. for a time period of 3 to 20 seconds. This not only sets the layer(s) 20 but adheres the particles 27 of catalyst more securely to the surface of the layer(s), thus making a permanent bond between the layers of polymerizable material and the layer 26 of catalyst.

At this stage the material may be re-coiled as indicated to form a second coil 14, although this re-coiling step is merely a convenience and could be eliminated, if desired.

In order to complete the preparation of separator plate for a fuel cell, it is usually necessary to complete various additional steps, e.g. cutting strips of the sheet article from the coiled band and shaping the cut strip, e.g. to produce channels for gaseous reactants passing through the cell. The cutting and stamping can, of course, be achieved in a single step. This is illustrated in simplified schematic form in FIG. 1, where a coil 14′ of the coated sheet article produced in the manner indicated above is uncoiled and fed to a cutting and stamping station 32 to produce individual separator plates 34 that can then be used in the manufacture of fuel cells.

As an alternative to this essentially continuous procedure, the sheet article may be cut and shaped as separator plate blanks before the coating procedures and then the various coating steps may be applied to the individual cut blanks.

### EXAMPLES

### Example 1

### Chemical Resistance

Samples of AA5182 aluminum alloy were chemically cleaned and pre-treated with a chromate conversion coating. This was done to provide good adhesion for subsequent coatings. The pre-treated samples were then coated with a 6 micron thick epoxy-based coating that was made electrically conductive by the addition of carbon black pigments. Coated specimens were immersed in 1.0 molar sulphuric acid solution at ambient temperature and at 80° C. for 14 days to simulate fuel cell exposure conditions. At the end of the exposure period, the specimens immersed under ambient temperature conditions were completely intact with no loss of coating adhesion and no blistering. The samples immersed at 80° C. exhibited blistering on much of the sample surface but this may have been related to the presence of defects in the coating. Nonetheless, the coating remained intact. In contrast, uncoated AA5182 alloy lost about 15 microns of metal thickness at ambient temperature and about 60 microns at 80° C. after the sulphuric acid immersion. The conductivity of the coating can be changed by varying the level and/or type of conductive pigment or coating thickness. However, coatings containing metallic pigments such as zinc to provide electrical conductivity exhibited poor resistance to the sulphuric acid.

### Example 2

### Bonding of the Catalyst

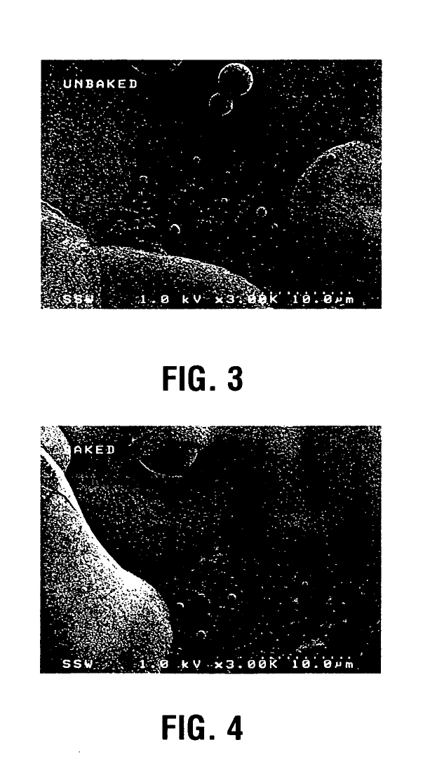

The coating employed in Example 1 is normally baked at a peak metal temperature (PMT) of about 230° C. in order to achieve a full cure. To bond a catalyst to the surface, samples were first baked at a PMT of only about 150° C. in order to drive off solvents and leave the coating dry to the touch without being fully cross-linked. An alumina catalyst was then transferred to the coated substrate by air spraying a dispersion of the alumina in methanol. The samples were then baked again to a PMT of 230° C. to fully cure the coating and at the same time bond the catalyst to the coated aluminum substrate. This process was deemed successful because, before baking, the catalyst powder could easily be removed from the substrate by simple gentle wiping but could not be removed after baking. FIGS. 3 and 4 are scanning electron micrograph images showing the catalyst on the surface before (FIG. 3) and after (FIG. 4) the second baking treatment. No differences in the catalyst were observed as a result of the baking.

Alumina was used in this example to illustrate the concept of binding of the catalyst to the coated surface. In practice, any catalyst may be employed in this fashion.

1. A method of producing a separator plate for a low temperature fuel cell, which method comprises:
providing a sheet article made of aluminum or aluminum alloy;
applying a layer of an electrically-conductive polymerizable material to a surface of the sheet article, the polymerizable material requiring an activation procedure to cause said material to polymerize fully;
coating a surface of the layer of electrically-conductive polymerizable material with at least one solid particulate catalyst to form a catalyst-coated layer of polymerizable material; and
subjecting the catalyst-coated layer of polymerizable material to said activation procedure to fully polymerize the polymerizable material, thereby forming a layer of polymerized electrically-conductive polymer adhering to the surface of the sheet article and to said at least one catalyst.

2. The method of claim 1, wherein said polymerizable material polymerizes when heated to an activation temperature, and wherein said activation procedure involves heating said sheet article to a temperature at or above said activation temperature.

3. The method of claim 1, wherein, after applying said layer of polymerizable material to said surface of said sheet article, the sheet article and applied layer are heated to a temperature below said activation temperature to dry said layer, at least partially, before said coating of said surface of said layer with said at least one solid particulate catalyst.

4. The method of claim 3, wherein said polymerizable material is dissolved or suspended in a volatile liquid having a vaporization temperature before being applied to said surface of said sheet article, and wherein said temperature below said activation temperature employed to dry said layer, at least partially, is at or above said vaporization temperature of said volatile liquid.

5. The method of claim 1, wherein said activation procedure is effected by exposing the electrically-conductive polymerizable material to radiation.

6. The method of claim 1, wherein said radiation comprises ultraviolet light.

7. The method of claim 1, wherein said surface of the sheet article is subjected to a procedure prior to applying said at least one layer of polymerizable material to enhance adhesion of said at least one layer to said at least one surface.

8. The method of claim 7, wherein said procedure is selected from the group consisting of etching, anodizing, conversion coating and mechanical roughening.

9. The method of claim 1, wherein said step of applying a layer of polymerizable material employs an organic pre-polymer or oligomer containing particles of an electrically-conductive solid.

10. The method of claim 9, wherein said electrically-conductive solid is carbon.

11. The method of claim 9, wherein said polymerizable material is selected from the group consisting of epoxy resin, polyester and polyurethane resin.

12. The method of claim 1, wherein said step of applying a layer of polymerizable material employs a pre-polymer or oligomer.

13. The method of claim 3, wherein said temperature below said activation temperature is in the range of 50 to 150° C.

14. The method of claim 3, wherein said temperature below said activation temperature is in the range of 60 to 120° C.

15. The method of claim 1, wherein the polymerizable material is applied to said surface of the sheet article to a thickness in the range of 2 to 20 μm.

16. The method of claim 1, wherein the polymerizable material is applied to said surface to a thickness in the range of 4 to 8 μm.

17. The method of claim 1, wherein said solid particulate catalyst is coated onto said surface of said polymerizable material in an amount in the range of 10 milligrams/square meter to 10 grams/square meter.

18. The method of claim 2, wherein said temperature at or above said activation temperature is in the range of 180 to 260° C.

19. The method of claim 2, wherein said temperature at or above said activation temperature is in the range of 190 to 230° C.

20. The method of claim 2, wherein said catalyst coated layer of polymerizable material is heated for a time in the range of 1 to 20 seconds.

21. The method of claim 2, wherein said catalyst coated layer of polymerizable material is heated for a time in the range of 1 to 3 seconds.

22. The method of claim 1, wherein said sheet article provided for said method is in the form of a coil and said steps of the method are carried out continuously as said sheet article is uncoiled, said article then being subjected to a final step of cutting and shaping to form said separator plate.

23. The method of claim 1, wherein said sheet article provided for said method has a shape and dimensions suitable as said separator plate.

24. The method of claim 1, wherein said sheet article has two surfaces and both surfaces are subjected to the steps of the method to provide a layer of conductive polymerized material coated with a solid catalyst on each said surface.

25. The method of claim 1, wherein said sheet article provided for said method is suitable as a bipolar separator plate for a low temperature fuel cell.

26. A separator plate for a low temperature fuel cell prepared by the method of claim 1.

27. A separator plate for a low temperature fuel cell, comprising:
a core made of aluminum or an aluminum alloy in the form of a sheet article;
a layer of an electrically-conductive polymer on a surface of said core; and
particles of a solid catalyst attached to an outer surface of said layer of electrically-conductive polymer.

28. The separator plate of claim 27, wherein said core has a surface treatment that improves attachment of said layer of electrically-conductive material to said core compared to attachment to said core obtainable without said surface treatment.

29. The separator plate of claim 27, wherein said core has two opposite surfaces and both said surfaces have said layer of electrically-conductive polymer and said attached particles of solid catalyst.
